(19) United States
(12) Patent Application Publication
(10) Pub. No.: US 2010/0182421 A1
(43) Pub. Date: Jul. 22, 2010

(54) METHODS AND APPARATUS FOR DETECTION AND CLASSIFICATION OF SOLAR CELL DEFECTS USING BRIGHT FIELD AND ELECTROLUMINESCENCE IMAGING

(76) Inventors: Mahendran T. Chidambaram, Saratoga, CA (US); S. Daniel Miller, San Jose, CA (US); Gerald Schock, Campbell, CA (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(21) Appl. No.: 12/690,894

(22) Filed: Jan. 20, 2010

Related U.S. Application Data
(60) Provisional application No. 61/145,955, filed on Jan. 20, 2009.

(51) Int. Cl. H04N 7/18; G06K 9/00

(52) U.S. Cl. 348/126; 382/149; 348/E07.085

(57) ABSTRACT

Methods and apparatus for integrated, in-line metrology of solar cells involve three distinct inspection and testing operations, prior to string and module assembly. Two of the inspections are performed by image analysis using bright field illumination. The third inspection involves electroluminescence imaging, where luminescence in the solar cell is achieved by inducing a forward bias in the solar cell, and analyzing a resulting grayscale image for defects.

### RELATED APPLICATIONS

This application is a NON-PROVISIONAL of, claims priority to and incorporates by reference U.S. Provisional Patent Application 61/145,955, filed 20 Jan. 2009.

### FIELD OF THE INVENTION

This invention relates to the testing of solar cells and tabbed solar cells prior to stringing the solar cells and to the inspection of interconnected solar cell strings prior to fabrication of solar modules.

### BACKGROUND

Traditionally, prior art photo voltaic (PV) cells are interconnected using a “tabbing and stringing” technique of soldering two or three conductive ribbons to the front surface of a first solar cell and to the back surface of an adjacent cell. Typically N (where N could be ten or twelve) PV cells are interconnected in this manner across one dimension of a solar array being manufactured. The process of attaching the ribbons to the PV cells is called “tabbing” and the process of connecting multiple PV cells together is called “stringing”. The main issue with this method of tabbing and stringing is that it does not allow for testing of the individual solar cells for qualitative or quantitative defect detection and rejection which in turn leads to structurally defective cells being stringed together and installed into sub-optimal modules, reducing overall performance efficiency of the solar module when installed in natural and harsh environments. This will then lead to degradation and early failure of the modules.

### SUMMARY OF THE INVENTION

According to one embodiment of the invention, an in-line, integrated metrology system includes bright field imaging means for acquiring an image of a solar cell to determine cracks and chipped edges present in the solar cell; means for acquiring a gray scale, electroluminescence (EL) image of the solar cell, after tabbing of the solar cell, by electrically biasing the solar cell to cause luminescence in the solar cell; means for analyzing the EL image of the solar cell to detect broken fingers, shunt localizations, and micro cracks in the solar cell; and means for acquiring an image of the solar cell after cross-stringing of the solar cell with other solar cells to inspect for solder quality by comparison with a reference image.

The means for analyzing the EL image may include an image analysis and classification module coupled to receive said gray scale image of the solar cell and configured to compare said gray scale image to a reference gray scale image to identify micro cracks, shunt localizations and broken fingers, thereby to classify the gray scale image of the solar cell. The bright field imaging means may include a charge coupled device (CCD) camera with a filter designed to block infra red (IR) and near-IR light, and one or more backside, high intensity illumination lamps. The means for acquiring an image may include a charge coupled device (CCD) camera.

A further embodiment of the invention provides a method for detecting defects in a solar cell. The method involves either inducing a forward bias voltage through the solar cell to cause-luminescence in the solar cell, or illuminating a solar cell with a light source to cause luminescence in the solar cell, and comparing a gray scale image of the solar cell (while exhibiting luminescence) with a reference gray scale image to identify and classify defects present in the solar cell. The gray scale image of the solar cell may be in the near infra red region of the electromagnetic spectrum and the steps of inducing/illuminating and comparing may be performed as in-line metrology operations during tabbing and stringing of said solar cell, preferably prior to creation of solar cell strings.

### BRIEF DESCRIPTION OF THE DRAWINGS

The present invention is illustrated by way of example in

FIG. 1, which is a block diagram of an in-line metrology system integrated to a fully automated cell assembling production system.

### DETAILED DESCRIPTION

To prevent catastrophic failure of expensive solar panels operating in the field, the present invention provides for a qualitative and, where appropriate, quantitative inspection and testing of individual solar cells as a fully automated, in-line process, prior to stringing and interconnection of the cells. Furthermore, after stringing, another level of inspection is provided for certifying solder quality before final module assembly. More particularly, the present invention provides methods and apparatus for in-line, qualitative, three-stage solar cell defect analysis and interconnected string inspection using bright field image inspection and electroluminescence (EL) imaging techniques. Electroluminescence involves excitation of luminescence achieved by forward biasing a finished solar cell and then analyzing a resulting grayscale image with an EL imaging camera. Luminescence, unlike incandescence or infra-red (IR) imaging, does not rely on the heating of the cell. The defect analysis and inspection is done in-line and is fully integrated on automated cell assemblers and automated cell tabbers. The present invention also allows for detection of cell defects, such as micro cracks, shunt localization, broken fingers, macro cracked cells, misaligned soldering, lack of soldering, etc. By providing detailed quality control data prior to string interconnect or module assembly, loss costs attributed to assembling of low efficiency stings and modules can be prevented.

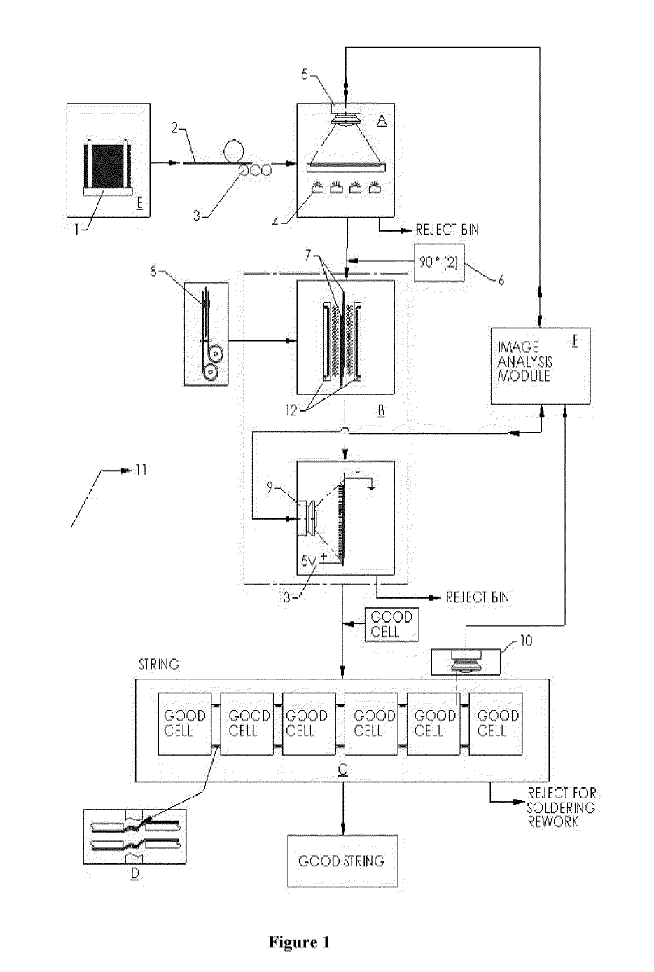

FIG. 1 shows an automated cell assembly production system with integrated metrology 11, wherein cells 2 are moved from a cell stack E, via cell handling mechanism 3, to a alignment and inspection station A, where first level inspection and alignment of the solar cell 2 is performed. Inspection of the solar cell 2 is performed by using a charged coupled device (CCD) camera with an optical filter that blocks light in the red and IR ranges 5, with backside high intensity illumination 4, to detect macroscopic cracks and chipped edges in the solar cell 2. The acquired raw image is then sent to an image analysis module F to determine if the solar cell 2 can be passed or rejected. If the solar cell 2 fails the first level inspection it is discarded into a reject bin and no further processing will be performed. If the solar cell 2 passes the first level inspection it is moved to the next station for further processing.

Upon passing the first level of inspection and alignment, solar cell 2 is rotated 90 degrees with vacuum handling mechanism 6. On the cell tabbing and testing station B, flat metal leads or tabs 7 are placed on the solar cell 2 by the tabbing mechanism 8, which adds front and, in one embodiment of this system, backside tabs. The flat metal tabs 7 are held in place against the cell with an “air knife” and are then soldered to the solar cell 2 at a very high speed. One preferred implementation uses electromagnetic soldering energy using an induction heating apparatus 12. Finally, the solar cell 2 is tabbed on the front and to the back in one soldering step.

Once the cell tabbing operation is completed the second level testing is performed on the tabbed solar cell 2 by inducing a forward bias voltage using a current generating source 13. Luminescence of the solar cell 2 is achieved by the forward biasing (as is well known in the art). The EL image is then captured by an EL imaging camera and lens 9 and transferred to the image analysis module F. Typical defects such as microscopic cracks (often referred to as micro cracks), shunt localization, broken fingers and/or tab soldering quality in the solar cell 2 can be detected by performing a grayscale image comparison with an EL image of a defective reference cell having some or all of the above-mentioned defects. The image analysis would involve correlating the brightness non-uniformity value as a percentage of the gray scale (as is well-known, the gray scale represents the total number of brightness levels available, for example between an inactive pixel and a completely active pixel). Based on the image analysis result, the tabbed solar cell 2 is passed or rejected. If the tabbed solar cell 2 passes the second level testing and inspection it is moved to the next station C for cell stringing and interconnect operation, else it is discarded to the reject bin.

At station C, the tabbed solar cell 2 is now deemed as a good cell (having passed both levels of testing and inspection) ready for interconnection with other, similar solar cells. In the embodiment illustrated in FIG. 1, cross-stringing two solar cells together can be accomplished using mechanism D (see, e.g., commonly-owned U.S. Provisional Patent Application 61/058,466 and U.S. patent application Ser. No. 12/477,723), which solders the flat tabs together and creates a stress relief bend if tabbing is performed at both the front and back of the cell, as described above. After the cross-stringing operation is complete, a third level inspection is performed using camera 10 to determine the quality of the cross-soldered strings. The acquired raw image is sent to the image analysis module F for determining if the cross-soldering is of sufficient quality by comparison with a reference image of an acceptable-quality cross-soldered cell. If it is determined that the quality of the soldering is not sufficient, the string is then rejected for rework and placed into a rework bin.

It should be understood that the techniques described above can be practiced in both fully automated systems and in stand alone testing and inspection systems. These techniques can be integrated as in-line metrology tools with string assemblers, or they can be practiced as stand alone metrology tools. One advantage of performing bright field and EL imaging on individual tabbed solar cells prior to stringing and module assembly is the potential for significant downstream cost savings and overall module efficiency improvements.

Although the foregoing description refers to illustrated embodiments of the invention, the details grading such an implementation should not be construed as limiting the scope of the invention but merely as illustrating features and aspects of the invention. It should be appreciated that the scope of the invention includes other embodiments not discussed in detail above. Upon review of the foregoing material, various modifications, changes and variations of the examples presented herein will be apparent to those skilled in the art and may be made in the arrangement, operation and details of the method and apparatus of the present invention disclosed herein without departing from the spirit and scope of the invention.

One alternative embodiment envisions inspection of the solar cell 2 performed using a CCD camera that accepts all visible light 5 with backside high intensity illumination 4 to detect cracks and chipped edges in the solar cell 2, while another embodiment envisions the use of a complementary metal oxide semiconductor (CMOS) or other technology sensor 5 for inspection of the wafer 2 for cracks and chips.

Another alternative embodiment envisions the use of mechanical or other means to hold the tabs 7 in place against the cell 2 during soldering, while another envisions the use of radiant, resistive, laser or other heating techniques used by the soldering apparatus 12 for soldering the tabs to the cells, either in a single pass or in multiple discreet steps.

Another alternative embodiment envisions soldering only a single, longer tab soldered to the front of the cell. In this alternative embodiment, the stringing process would entail laying the tab from the front of a current cell across the back of a previous cell and soldering the tab to the back of said previous cell using any of the soldering techniques discussed above.

Another alternative embodiment envisions the use of photoluminescence (PL), a process that uses light instead of electrical energy to excite the PV cell into luminescence. In this embodiment, the camera 9 is of the same technology but instead of circuitry 13 to forward bias the PV cell 2, a laser or other light source (e.g., a xenon lamp) of appropriate frequency and intensity to excite luminescence (as opposed to generating electron-hole pairs) is used. In yet another alternative embodiment, both electroluminescent imaging and photoluminescent imaging is used to maximize the available defect detection information.

Thus, methods and apparatus for in-line, qualitative, three-stage solar cell defect analysis and interconnected string inspection using bright field image inspection and EL imaging techniques have been described, but the scope of the invention should be measured only in terms of the claims, which follow.

What is claimed is:

1. An in-line, integrated metrology system, comprising:
bright field imaging means for acquiring an image of a solar cell to determine cracks and chipped edges present in the solar cell;
means for acquiring a gray scale, electroluminescence (EL) image of the solar cell, after tabbing of the solar cell, by electrically biasing the solar cell to cause luminescence in the solar cell;
means for analyzing the EL image of the solar cell to detect broken fingers, shunt localizations, and micro cracks in the solar cell; and
means for acquiring an image of the solar cell after cross-stringing of the solar cell with other solar cells to inspect for solder quality by comparison with a reference image.

2. The system of claim 1, wherein the means for analyzing the EL image comprise an image analysis and classification module coupled to receive said gray scale image of the solar cell and configured to compare said gray scale image to a reference gray scale image to identify micro cracks, shunt localizations and broken fingers, thereby to classify the gray scale image of the solar cell.

3. The system of claim 1, wherein the bright field imaging means comprise a charge coupled device (CCD) camera with a filter designed to block infra red (IR) and near-IR light, and one or more backside, high intensity illumination lamps.

4. The system of claim 1, wherein the means for acquiring an image comprise a charge coupled device (CCD) camera.

5. A method for detecting defects in a solar cell, comprising inducing a forward bias voltage through the solar cell to cause luminescence in the solar cell, and comparing a gray scale image of the solar cell with a reference gray scale image to identify and classify defects present in the solar cell.

6. The method of claim 5 wherein the gray scale image of the solar cell is in the near infra red region of the electromagnetic spectrum.

7. The method of claim 5 wherein the steps of inducing and comparing are performed as in-line metrology operations during tabbing and stringing of said solar cell.

8. The method of claim 7 wherein the inducing and comparing are performed prior to creation of solar cell strings.

9. A method for detecting defects in a solar cell, comprising illuminating a solar cell with a light source to cause luminescence in the solar cell, and comparing a gray scale image of the solar cell with a reference gray scale image to identify and classify defects present in the solar cell.

10. The method of claim 9 wherein the gray scale image of the solar cell is in the near infra red region of the electromagnetic spectrum.

11. The method of claim 9 wherein the steps of illuminating and comparing are performed as in-line metrology operations during tabbing and stringing of said solar cell.

12. The method of claim 11 wherein the illuminating and comparing are performed prior to creation of solar cell strings.
